(19) United States
(12) Patent Application Publication
(10) Pub. No.: US 2026/0061376 A1
(43) Pub. Date: Mar. 5, 2026

(54) GAS INJECTION MODULE AND ACTIVE GAS INJECTION SYSTEM

(71) Applicant: RAYZHER INDUSTRIAL CO., LTD, Hsinchu County (TW)

(72) Inventors: KU-HUA CHOU, Hsinchu County (TW); KUEN-YI WU, Hsinchu County (TW)

(21) Appl. No.: 18/951,949

(22) Filed: Nov. 19, 2024

(30) Foreign Application Priority Data
Aug. 29, 2024 (TW) 113132543

(51) Int. Cl. B01F 25/314; B01F 23/10; B01F 25/00

(52) U.S. Cl. CPC B01F 25/3143; B01F 23/10; B01F 2025/913

(57) ABSTRACT

A gas injection module and an active gas injection system are provided. The gas injection module includes a device body, the internal of which has a delivering cavity and an annular gas-flow generation cavity. One end of the device body has a gas input portion, and another end thereof has a gas output portion. One side of the device body is configured to extend outward to form a gas guiding portion. The annular gas flow generation cavity includes a side connecting portion and a nozzle portion in spatial communication with each other. The side connecting portion is connected to the gas guiding portion. The nozzle portion is connected to the delivering cavity. The nozzle portion is configured for generating a pushing gas-flow in a pre-determined path toward the delivering cavity. A pre-determined angle between 0-89 degrees is between the pre-determined path and central axis of the device body.

### CROSS-REFERENCE TO RELATED PATENT APPLICATION

This application claims the benefit of priority to Taiwan Patent Application No. 113132543, filed on Aug. 29, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a gas injection module and an active gas injection system, and more particularly to a gas injection module and an active gas injection system for replacing the existing pipe heating zones and generating a gas flow in a specific angle.

### BACKGROUND OF THE DISCLOSURE

For the processing system for exhausted gas having particles and dust used in the high-tech manufacturing, fine dust should be collected from the exhausted gas before and after detoxification. In a semiconductor processing apparatus, wet local scrubbers are adopted for filtering the fine dust, and the exhausted gas having the fine dust is delivered through pipes. In the circumstance of delivering the exhausted gas having fine dust for a long time, the dust in the exhausted gas will be accumulated on pipe walls, resulting in the problem of the clogging of the pipes. Therefore, a plurality of heating zones are arranged on the pipes to prevent the dust accumulated on the pipe walls from clumping, and the dust can thus be taken away from the pipes by the exhausted gas.

However, the inclusion of the heating zones increases the manufacturing cost, and the heating zones cannot completely eliminate the need of cleaning the pipes.

### SUMMARY OF THE DISCLOSURE

In response to the above-referenced technical inadequacies, the present disclosure provides a gas injection module and an active gas injection system.

In order to solve the above-mentioned problems, one of the technical aspects adopted by the present disclosure is to provide a gas injection module. The gas injection module includes a device body. An inside of the device body has a delivering cavity and an annular gas flow generation cavity. One end of the device body has a gas input portion, and another end of the device body has a gas output portion. A lateral side of the device body is configured to extend outward to form a gas guiding portion. The delivering cavity, the gas input portion, and the gas output portion are in spatial communication with one another, and the delivering cavity, the annular gas flow generation cavity, and the gas guiding portion are in spatial communication with one another. The gas input portion is configured for being connected to a first external operating apparatus, the gas output portion is configured for being connected to a second external operating apparatus, and the gas guiding portion is configured for being connected to an external gas source device. The annular gas flow generation cavity has a side connecting portion and at least one nozzle portion, the side connecting portion is in spatial communication with the at least one nozzle portion, and the side connecting portion is connected to the gas guiding portion. The at least one nozzle portion is connected to the delivering cavity and is configured to generate a pushing gas flow to the delivering cavity along a pre-determined path, a pre-determined angle is defined between the pre-determined path and a central axis of the device body, and the pre-determined angle is between 0 degrees and 89 degrees.

In order to solve the above-mentioned problems, another one of the technical aspects adopted by the present disclosure is to provide an active gas injection system. The active gas injection system includes: at least one gas injection module, at least one gas supply module, and a control module. The at least one gas injection module has a device body. An inside of the device body has a delivering cavity and an annular gas flow generation cavity. One end of the device body has a gas input portion, and another end of the device body has a gas output portion. A lateral side of the device body extends outward to form a gas guiding portion. The delivering cavity, the gas input portion and the gas output portion are in spatial communication with one another, and the delivering cavity, the annular gas flow generation cavity and the gas guiding portion are in spatial communication with one another. The at least one gas supply module is connected to the gas guiding portion. The control module is connected to the at least one gas supply module. The control module is configured to control the at least one gas supply module to supply a driving gas flow to the gas injection module in a continuous manner or an intermittent manner. The gas input portion is configured for being connected to a first external operating apparatus, and the gas output portion is configured for being connected to a second external operating apparatus. The annular gas flow generation cavity has a side connecting portion and at least one nozzle portion. The side connecting portion is in spatial communication with the at least one nozzle portion, and the side connecting portion is connected to the gas guiding portion. The at least one nozzle portion is connected to the delivering cavity and is configured to generate a pushing gas flow to the delivering cavity along a pre-determined path. A pre-determined angle is defined between the pre-determined path and a central axis of the device body, and the pre-determined angle is between 0 degrees and 89 degrees.

Therefore, the gas injection module and the active gas injection system provided by the present disclosure can replace the existing pipe heating zones and effectively solve the clogging problem of the pipes by means of the above technical features.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic structural view of an active gas injection system according to a first embodiment of the present disclosure;

FIG. 2 is a functional block diagram of the active gas injection system according to the first embodiment of the present disclosure;

FIG. 3 is a schematic cross-sectional view of a gas injection module according to the first embodiment of the present disclosure;

FIG. 4 is another schematic cross-sectional view of the gas injection module according to the first embodiment of the present disclosure;

FIG. 5 is a schematic structural view of the active gas injection system according to a second embodiment of the present disclosure; and

FIG. 6 is a functional block diagram of the active gas injection system according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

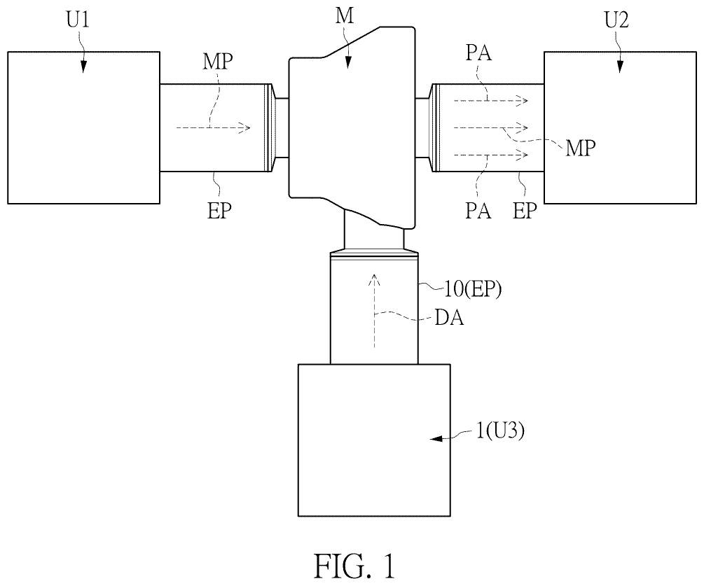

Reference is made to FIG. 1 to FIG. 4, which are a schematic structural view of an active gas injection system, a functional block diagram of the active gas injection system, and schematic cross-sectional views of the gas injection module according to the first embodiment of the present disclosure, respectively. As shown in the figures mentioned above, the first embodiment of the present disclosure provides an active gas injection system Z, which includes at least one gas injection module M, at least one gas supply module 1, and a control module 2.

As shown in FIG. 1 to FIG. 4, the gas injection module M can include a device body M1, and an inside of the device body M1 can have a delivering cavity M10 and an annular gas flow generation cavity M11. One end of the device body M1 can have a gas input portion M2, and another end of the device body M1 can have a gas output portion M3. A lateral side of the device body M1 is configured to extend outward to form a gas guiding portion M4. The delivering cavity M10, the gas input portion M2, and the gas output portion M3 can be in spatial communication with one another, and the delivering cavity M10, the annular gas flow generation cavity M11, and the gas guiding portion M4 can be in spatial communication with one another. The gas input portion M2 is configured to be connected to a first external operating apparatus U1, and the gas output portion M3 is configured to be connected to a second external operating apparatus U2. The annular gas flow generation cavity M11 includes a side connecting portion M110 and at least one nozzle portion M111, and the side connecting portion M110 and the at least one nozzle portion M111 are in spatial communication with each other. The side connecting portion M110 is connected to the gas guiding portion M4, and the nozzle portion M111 is connected to the delivering cavity M10. The nozzle portion M111 can be configured to generate a pushing gas flow PA to the delivering cavity M10 along a pre-determined path PR. A pre-determined angle PG is defined between the pre-determined path PR and a central axis CA of the device body M1, and the pre-determined angle PG is between 0 degrees and 89 degrees.

For example, the shape of the device body M1 can be any geometrical shape, such as square or rounded trapezoid (but is not limited thereto). The delivering cavity M10 can be disposed at a center of the device body M1, and the annular gas flow generation cavity M11 is configured to surround the delivering cavity M10. The delivering cavity M10 can be a hollow structure. One end of the device body M1 is configured to extend outward to form the gas input portion M2, and another end of the device body M1 is configured to extend outward to form the gas output portion M3. The gas input portion M2, the gas output portion M3, and the gas guiding portion M4 can be hollow tube structures. The gas input portion M2 can be in spatial communication with the gas output portion M3 through the delivering cavity M10, and the gas guiding portion M4 can be in spatial communication with the delivering cavity M10 through the annular gas flow generation cavity M11. The diameter or aperture of the nozzle portion M111 can be between 0.01 mm and 3 mm, and is preferably 0.1 mm. Furthermore, the pre-determined angle PG is preferably between 0 to 10 degrees, and is more preferably to be 0 degrees. Each of the first external operating apparatus U1 and the second external operating apparatus U2 can be a turbo pump, a dry pump, a local scrubber, a combustion-type exhausted gas removing apparatus, a plasma-type exhausted gas removing apparatus, or a central scrubber (but is not limited thereto). The gas input portion M2 can be connected to the first external operating apparatus U1 through an external pipe EP, and the gas output portion M3 can be connected to the second external operating apparatus U2 through the external pipe EP.

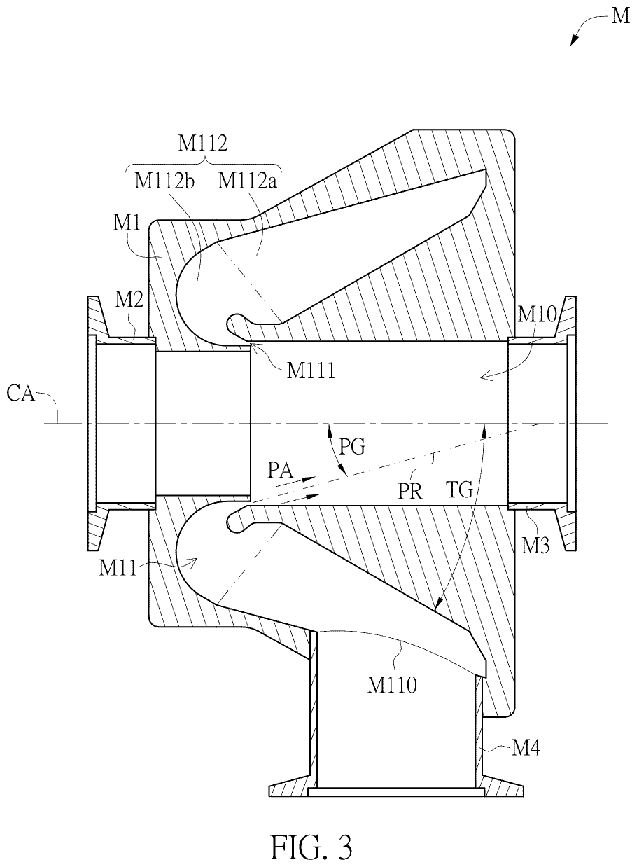

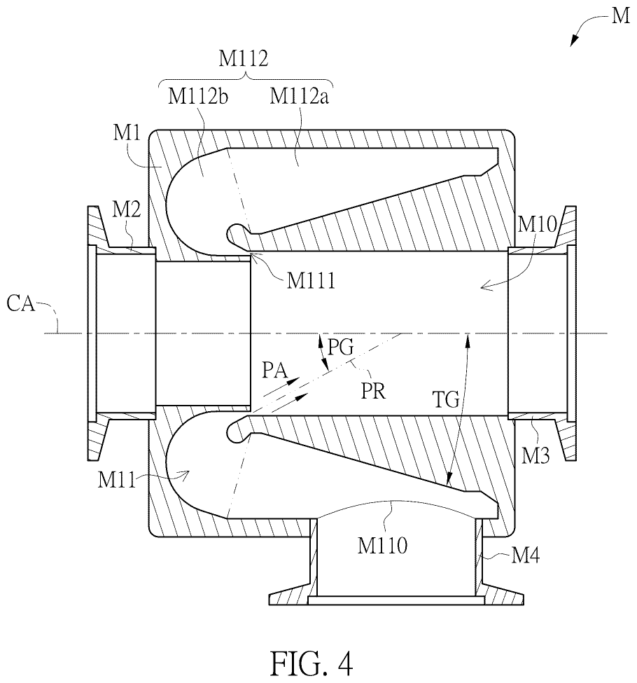

Furthermore, the cross-section of the annular gas flow generation cavity M11 can be in a feather shape, and the annular gas flow generation cavity M11 can be an annular hollow structure. The annular gas flow generation cavity M11 further includes a main cavity portion M112 having a covert region M112a and a shoulder region M112b. The covert region M112a is configured to connect the side connecting portion M110 and the shoulder region M112b, and the shoulder region M112b is connected to the at least one nozzle portion M111. A cross-section of the covert region M112a can be in a conical shape, and a cross-section of the shoulder region M112b can be in a C-shape or a hook shape (but are not limited thereto). Moreover, a pre-determined tilt angle TG is defined between an internal wall of the device body M1 corresponding to the covert region M112a and adjacent to the delivering cavity M10 and the central axis CA, and the pre-determined tilt angle TG can be between 5 degrees and 30 degrees, preferably is 8 degrees, 16 degrees (as shown in FIGS. 4), 19 degrees, 26.5 degrees, and 30 degrees (as shown in FIG. 3) (but is not limited thereto).

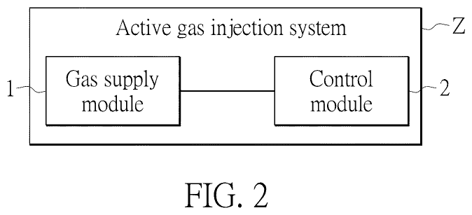

Then, as shown in FIG. 1 and FIG. 2, the at least one gas supply module 1 is connected to the gas guiding portion M4. For example, the gas supply module 1 can be a gas supplying device in the semiconductor apparatus for supplying air or special gas (such as inert gases, but is not limited thereto). The gas supply module 1 includes a connecting pipe 10 which is connected to the gas guiding portion M4.

Next, as shown in FIG. 2, the control module 2 is electrically connected to the gas supply module 1, and is configured for controlling the gas supply module 1 to supply a driving gas flow DA to the gas injection module M in a continuous manner or an intermittent manner. For example, the control module 2 can be a central control apparatus or computer apparatus. In other preferable embodiments, the control module 2 can also be connected to the first external operating apparatus U1 and the second external operating apparatus U2, and is configured to receive information provided by the first external operating apparatus U1 and the second external operating apparatus U2 (such as the signals of the parameters relating to gas delivery).

Therefore, when the gas guiding portion M4 receives a driving gas flow DA provided by the gas supply module 1, and when the gas input portion M2 is configured to receive a processing gas MP provided by the first external operating apparatus U1, the annular gas flow generation cavity M11 can generate a pushing gas flow PA toward the delivering cavity M10 by the at least one nozzle portion M111, such that the pushing gas flow PA is configured to carry the processing gas MP and to flow to the gas output portion M3. When the gas guiding portion M4 is configured to receive the driving gas flow DA provided by the gas supply module 1, the annular gas flow generation cavity M11 is configured to guide the driving gas flow DA into the covert region M112a through the side connecting portion M110. The driving gas flow DA is configured to sequentially flow through the covert region M112a and the shoulder region M112b, and is configured to flow toward the delivering cavity M10 along the pre-determined path PR through the at least one nozzle portion M111 to form the pushing gas flow PA.

For example, as shown in FIG. 1 to FIG. 4, the active gas injection system Z of the present disclosure can be applied to a semiconductor processing apparatus, and replace pipe heating zones in the existing semiconductor processing apparatus. Therefore, when the active gas injection system Z of the present disclosure is operating, the gas injection module M receives the processing gas MP provided by the first external operating apparatus U1 (such as harmful gas having fine dust, e.g., exhausted gas, but is not limited thereto). Then, the control module 2 is configured to control the gas supply module 1 to supply a driving gas flow DA (such as a gas flow of inert gases, but is not limited thereto) to the gas injection module M. At this time, after the driving gas flow DA enters the annular gas flow generation cavity M11 from the gas guiding portion M4, the driving gas flow DA is configured to sequentially flow through the covert region M112a and the shoulder region M112b, and is configured to generate swirls in the annular gas flow generation cavity M11 (i.e., flowing in the annular gas flow generation cavity M11 in a swirling manner), and then the driving gas flow DA is injected into the delivering cavity M10 by the nozzle portion M111. The nozzle portion M111 is capable of injecting the driving gas flow DA to the delivering cavity M10 along the pre-determined path PR (i.e., a specific injection direction or a pre-determined injection direction), such that the driving gas flow DA forms the pushing gas flow PA. The pushing gas flow PA can be an annular gas flow.

Next, when the pushing gas flow PA is injected inside the delivering cavity M10, the pushing gas flow PA will flow toward the gas output portion M3 along the pre-determined path PR (i.e., the pre-determined injection direction). At the same time, the pushing gas flow PA will draw and absorb the processing gas MP introduced by the gas input portion M2 into the pushing gas flow PA, and will be combined with the processing gas MP to form a strong and stable gas flow flowing toward the gas output portion M3. Finally, the processing gas MP is entirely pushed and carried to the second external operating apparatus U2 by the pushing gas flow PA, such that the dust in the processing gas MP does not remain in the external pipe EP anymore.

It is worth mentioning that the control module 2 of the present disclosure can control the gas supply module 1 to continuously or intermittently (e.g., supplying the gas every 5 seconds, but is not limited thereto) supply the driving gas flow DA to the gas injection module M according to a built-in program or an arbitrary operation. Also, a flow range of the pushing gas flow PA is between 1 SLM and 600 SLM.

In this way, by virtue of the above technical features, the active gas injection system Z of the present disclosure is capable of providing an active annular gas flow by disposing the gas injection module M, the gas supply module 1, and the control module 2 between the first external operating apparatus U1 and the second external operating apparatus U2, and is capable of providing the pushing gas flow PA by the gas injection module M to carry the processing gas MP to completely flow to the second external operating apparatus U2, so as to prevent the dust in the processing gas MP from remaining in the external pipe EP. At the same time, an existing manner of heating the pipe by the heating zones in the current semiconductor processing to solve the clogging problem of the pipes can be replaced, and the costs of manufacturing and apparatus maintenance can be significantly reduced.

In addition, based on the above-mentioned descriptions, as shown in FIG. 1 to FIG. 4, the present disclosure further provides a gas injection module M that includes a device body M1. An inside of the device body M1 includes a delivering cavity M10 and an annular gas flow generation cavity M11. One end of the device body M1 has a gas input portion M2, and another end of the device body M1 has a gas output portion M3. A lateral side of the device body M1 is configured to extend outward to form a gas guiding portion M4. The delivering cavity M10, the gas input portion M2, and the gas output portion M3 can be in spatial communication with one another, and the delivering cavity M10, the annular gas flow generation cavity M11, and the gas guiding portion M4 can be in spatial communication with one another. The gas input portion M2 is configured for connecting a first external operating apparatus U1, and the gas output portion M3 is configured for connecting a second external operating apparatus U2. The gas guiding portion M4 is configured for connecting an external gas source device U3 (which can be identical to the gas supply module 1, such as a gas supplying device in a semiconductor apparatus that can supply air or a special gas, e.g., an inert gas, but is not limited thereto). The annular gas flow generation cavity M11 includes a side connecting portion M110 and at least one nozzle portion M111, and the side connecting portion M110 and the at least one nozzle portion M111 are in spatial communication with each other. The side connecting portion M110 can be connected to the gas guiding portion M4, and the at least one nozzle portion M111 can be connected to the delivering cavity M10, and the at least one nozzle portion M111 is configured to generate a pushing gas flow PA toward the delivering cavity M10 along a pre-determined path PR. A pre-determined angle PG is between the pre-determined path PR and a central axis CA of the device body M1, and the pre-determined angle PG can be between 0 degrees and 89 degrees.

However, the aforementioned details are disclosed for exemplary purposes only, and are not meant to limit the scope of the present disclosure.

### Second Embodiment

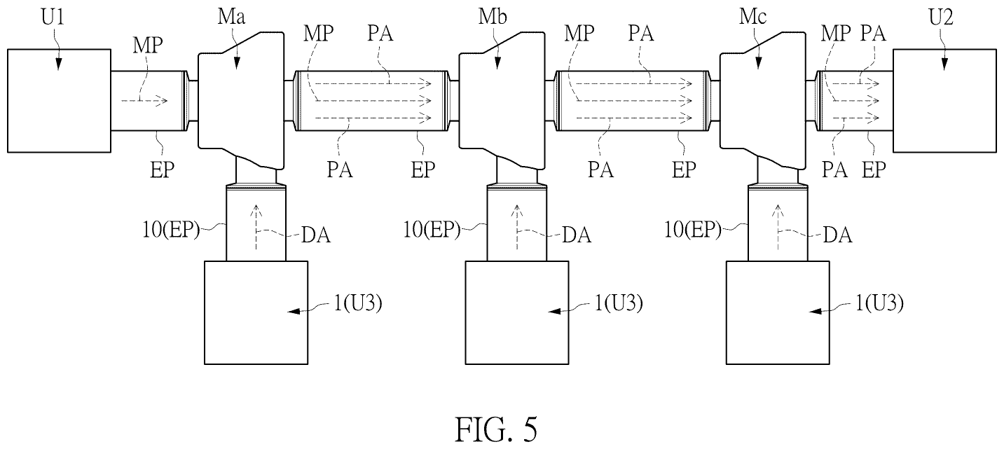

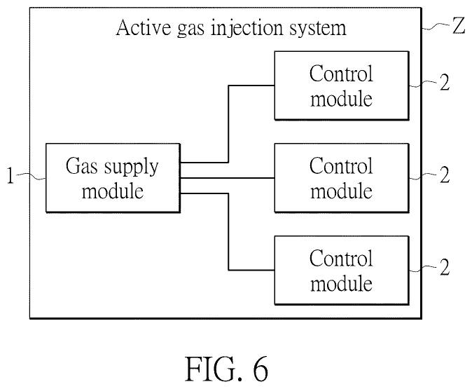

Reference is made to FIG. 5 and FIG. 6, which are a schematic structural view of the active gas injection system and a functional block diagram of the active gas injection system according to a second embodiment of the present disclosure, respectively, and reference is made in conjunction to FIG. 1 to FIG. 4. As shown in the figures, the active gas injection system Z in the present embodiment is similar to the active gas injection system Z in the previous embodiment. Hence, the arrangements or actions of the same components in the embodiments will not be reiterated herein. The difference between the present embodiment and the previous embodiment is that, in the present embodiment, the active gas injection system Z can further include a plurality of gas injection modules Ma, Mb, Mc. The gas input portion M2 of the gas injection module Ma can be connected to the first external operating apparatus U1, and the gas output portion M3 of the gas injection module Mb can be connected to the gas input portion M2 of the gas injection module Ma. The gas output portion M3 of the gas injection module Mc can be connected to the second external operating apparatus U2, and the gas guiding portions M4 of the gas injection modules Ma, Mb, Mc can be connected to the at least one gas supply module 1.

For example, as shown in FIG. 3 to FIG. 6, in the active gas injection system Z, the plurality of gas injection modules Ma, Mb, Mc can be disposed between the first external operating apparatus U1 and second external operating apparatus U2 with equal or unequal spacing therebetween. Moreover, each of the gas injection modules Ma, Mb, Mc can be connected to different ones of the gas supply modules 1 individually, or the gas injection modules Ma, Mb, Mc can be connected to the same gas supply module 1. Therefore, when the distance between the first external operating apparatus U1 and the second external operating apparatus U2 is excessively long (i.e., the length of the external pipe EP being longer), or when the external pipe EP between the first external operating apparatus U1 and the second external operating apparatus U2 is not a straight pipe but consists of straight pipes and curved pipes, the gas injection modules M can be disposed in different positions on the pipe path of the external pipe EP. Then, by the mode of the control module 2 controlling the gas supply module 1 to supply the driving gas flow DA (e.g., continuously or intermittently), the gas injection modules Ma, Mb, Mc are driven to fully deliver the processing gas MP from the first external operating apparatus U1 to the second external operating apparatus U2 in a relay manner.

In particular, the control module 2 can control the gas supply module 1 corresponding to the gas injection module Ma to supply the driving gas flow DA first to the gas injection module Ma, and the gas supply modules 1 corresponding to the gas injection modules Mb, Mc temporarily do not supply the driving gas flow DA. Then, after a period of time has elapsed (such as after five seconds, but is not limited thereto), the control module 2 is configured to control the gas supply module 1 corresponding to the gas injection module Mb to supply the driving gas flow DA to the gas injection module Mb, and is configured to control the gas supply modules 1 corresponding to the gas injection modules Ma, Mc temporarily not to supply the driving gas flow DA at the same time. At this time, the processing gas MP has been carried to the gas injection module Mb by the pushing gas flow PA generated by the gas injection module Ma, and then is carried to the gas injection module Mc by the pushing gas flow PA generated by the gas injection module Mb. Next, after another period of time has elapsed (such as after five seconds, but is not limited thereto), the control module 2 is configured to control the gas supply module 1 corresponding to the gas injection module Mc to supply the driving gas flow DA to the gas injection module Mc, and is configured to control the gas supply modules 1 corresponding to the gas injection modules Ma, Mb temporarily not to supply the driving gas flow DA at the same time. At this time, the processing gas MP has been carried to the gas injection module Mc by the pushing gas flow PA generated by the gas injection module Mb, and is further carried to the second external operating apparatus U2 by the pushing gas flow PA generated by the gas injection module Mc.

However, the control module 2 can control the gas supply modules 1 corresponding to the gas injection modules Ma, Mb, Mc together to continuously supply the driving gas flow DA to the gas injection modules Ma, Mb, Mc, so as to drive the gas injection modules Ma, Mb, Mc to generate the pushing gas flow PA together, such that the processing gas MP provided by the first external operating apparatus U1 is carried to the second external operating apparatus U2.

It should be noted that, the flow range of the pushing gas flow PA generated by the gas injection modules Ma, Mb, Mc of the active gas injection system Z of the present disclosure can be between 1 SLM and 600 SLM.

However, the aforementioned details are disclosed for exemplary purposes only, and are not meant to limit the scope of the present disclosure.

### Beneficial Effects of the Embodiments

In conclusion, the gas injection module M and the active gas injection system Z provided by the present disclosure is capable of replacing the existing pipe heating zones and effectively solving the clogging problem of the pipes by virtue of the technical features described above.

In particular, by virtue of the technical features described above, the active gas injection system Z of the present disclosure is configured to provide an active annular gas flow by a gas injection module M, a gas supply module 1, and a control module 2 being disposed between the first external operating apparatus U1 and the second external operating apparatus U2, and is configured to prevent the dust in the processing gas MP from remaining in the external pipe EP by fully carrying the processing gas MP to the second external operating apparatus U2 by the pushing gas flow PA provided by the gas injection module M in a specific direction (i.e., along the pre-determined path PR), so as to solve the clogging problem of the pipes in the semiconductor industry, without the need of an additional power supply. At the same time, the active gas injection system of the present disclosure can replace the manner of heating the pipes having heating zones in the current semiconductor processing for solving the clogging problem of the pipes. Since the heating zones are not necessary for the pipes, the costs of manufacturing and apparatus maintenance can be significantly reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A gas injection module, comprising:
a device body, wherein an inside of the device body has a delivering cavity and an annular gas flow generation cavity, one end of the device body has a gas input portion, and another end of the device body has a gas output portion; wherein a lateral side of the device body extends outward to form a gas guiding portion; the delivering cavity, the gas input portion, and the gas output portion are in spatial communication with one another, and the delivering cavity, the annular gas flow generation cavity, and the gas guiding portion are in spatial communication with one another;
wherein the gas input portion is configured for being connected to a first external operating apparatus, the gas output portion is configured for being connected to a second external operating apparatus, and the gas guiding portion is configured for being connected to an external gas source device; and
wherein the annular gas flow generation cavity has a side connecting portion and at least one nozzle portion, the side connecting portion is in spatial communication with the at least one nozzle portion, and the side connecting portion is connected to the gas guiding portion; wherein the at least one nozzle portion is connected to the delivering cavity and is configured to generate a pushing gas flow to the delivering cavity along a pre-determined path, a pre-determined angle is defined between the pre-determined path and a central axis of the device body, and the pre-determined angle is between 0 degrees and 89 degrees.

2. The gas injection module according to claim 1, wherein, when the gas guiding portion receives a driving gas flow provided by the external gas source device, and when the gas input portion receives a processing gas provided by the first external operating apparatus, the annular gas flow generation cavity is configured to generate the pushing gas flow to the delivering cavity by the at least one nozzle portion, such that the pushing gas flow carries the processing gas to flow toward the gas output portion;
wherein the pushing gas flow is an annular gas flow.

3. The gas injection module according to claim 1, wherein the pre-determined angle is between 0 degrees and 10 degrees; wherein the delivering cavity is located at a center of the device body, and the annular gas flow generation cavity is configured to surround the delivering cavity; wherein a flow range of the pushing gas flow generated by the gas injection module is between 1 SLM and 600 SLM.

4. The gas injection module according to claim 1, wherein a cross-section of the annular gas flow generation cavity is in a feather shape, the annular gas generation cavity further has a main cavity portion having a covert region and a shoulder region, and the covert region is configured to connect the side connecting portion and the shoulder region; wherein the shoulder region is configured for being connected to the at least one nozzle portion, a cross-section of the covert region is in a conical shape, and a cross-section of the shoulder region is in a C-shape or a hook shape.

5. The gas injection module according to claim 4, wherein, when the gas guiding portion receives a driving gas flow provided by the external gas source device, the annular gas flow generation cavity is configured to guide the driving gas flow into the covert region by the side connecting portion; wherein the driving gas flow is configured to sequentially flow through the covert region and the shoulder region, and is configured to flow toward the delivering cavity along the pre-determined path through the at least one nozzle portion, so as to form the pushing gas flow.

6. An active gas injection system, comprising:
at least one gas injection module having a device body, wherein an inside of the device body has a delivering cavity and an annular gas flow generation cavity, one end of the device body has a gas input portion, and another end of the device body has a gas output portion; wherein a lateral side of the device body extends outward to form a gas guiding portion; the delivering cavity, the gas input portion and the gas output portion are in spatial communication with one another, and the delivering cavity, the annular gas flow generation cavity, and the gas guiding portion are in spatial communication with one another;
at least one gas supply module connected to the gas guiding portion; and
a control module connected to the at least one gas supply module, wherein the control module is configured to control the at least one gas supply module to supply a driving gas flow to the gas injection module in a continuous manner or an intermittent manner;
wherein the gas input portion is configured for connecting a first external operating apparatus, and the gas output portion is configured for connecting a second external operating apparatus; and
wherein the annular gas flow generation cavity has a side connecting portion and at least one nozzle portion, the side connecting portion is in spatial communication with the at least one nozzle portion, and the side connecting portion is connected to the gas guiding portion; wherein the at least one nozzle portion is connected to the delivering cavity and is configured to generate a pushing gas flow to the delivering cavity along a pre-determined path, a pre-determined angle is defined between the pre-determined path and a central axis of the device body, and the pre-determined angle is between 0 degrees and 89 degrees.

7. The active gas injection system according to claim 6, further comprising a plurality ones of the gas injection module, wherein the gas input portion of one of the gas injection modules is connected to the first external operating apparatus, the gas output portion of the one of the gas injection modules is connected to the gas input portion of another one of the gas injection modules, and the gas output portion of the another one of the gas injection modules is connected to the second external operating apparatus, and the gas guiding portions of the gas injection modules are connected to the at least one gas supply module.

8. The active gas injection system according to claim 6, wherein, when the gas guiding portion receives a driving gas flow provided by the at least one gas supply module, and when the gas input portion receives a processing gas provided by the first external operating apparatus, the annular gas flow generation cavity is configured to generate the pushing gas flow to the delivering cavity by the at least one nozzle portion, such that the pushing gas flow carries the processing gas to flow toward the gas output portion; wherein the pushing gas flow is an annular gas flow; and wherein a flow range of the pushing gas flow generated by the gas injection module is between 1 SLM and 600 SLM.

9. The active gas injection system according to claim 6, wherein the pre-determined angle is between 0 degrees and 10 degrees, the delivering cavity is located at a center of the device body, and the annular gas flow generation cavity surrounds the delivering cavity; wherein a cross-section of the annular gas flow generation cavity is in a feather shape, the annular gas flow generation cavity further has a main cavity portion having a covert region and a shoulder region; wherein the covert region is configured to connect the side connecting portion and the shoulder region, the shoulder region is connected to the at least one nozzle portion, and a cross-section of the covert region is in a conical shape, and a cross-section of the shoulder region is in a C-shape or a hook shape.

10. The active gas injection system according to claim 9, wherein, when the gas guiding portion receives a driving gas flow provided by the at least one gas supply module, the annular gas flow generation cavity is configured to guide the driving gas flow into the covert region by the side connecting portion; wherein the driving gas flow is configured to sequentially flow through the covert region and the shoulder region, and is configured to flow toward the delivering cavity along the pre-determined path through the at least one nozzle portion, so as to form the pushing gas flow.
